(19) United States
(12) Patent Application Publication
(10) Pub. No.: US 2009/0051568 A1
(43) Pub. Date: Feb. 26, 2009

(54) METHOD AND APPARATUS FOR TRAFFIC CONTROL USING RADIO FREQUENCY IDENTIFICATION TAGS

(76) Inventors: Kevin Michael Corry, Pflugerville, TX (US); Mark Alan Peloquin, Austin, TX (US); Steven Pratt, Leander, TX (US); Karl Milton Rister, Austin, TX (US)

Correspondence Address: IBM CORP (YA);C/O YEE & ASSOCIATES PC, P.O. BOX 802333, DALLAS, TX, 75380, US

(21) Appl. No.: 11/842,723

(22) Filed: Aug. 21, 2007

(51) Int. Cl. G08G 1/01

(52) U.S. Cl. 340/935; 340/10.1; 340/936; 701/117

(57) ABSTRACT

A computer implemented method, apparatus, and computer usable program code for controlling traffic. A set of vehicles is monitored moving from one radio frequency identification tag sensor to another radio frequency identification tag sensor in a network of radio frequency identification tag sensors to detect movement of the set of vehicles. A set of traffic patterns is identified in response to detecting the movement of the set of vehicles. A determination is made as to whether a traffic pattern in the set of traffic patterns is a delayed traffic pattern. In response to a determination that the traffic pattern in the set of traffic patterns is the delayed traffic pattern for a traffic control light at an intersection, the timing of the traffic control light is changed to increase traffic flow through the intersection.

### BACKGROUND OF THE INVENTION

1. Field of the Invention

The present invention relates generally to an improved data processing system and in particular to a method and apparatus for identifying the location of vehicles using radio frequency identification tags. Still more particularly, the present invention relates to a computer implemented method, apparatus, and computer usable program code for traffic control using radio frequency identification tags in vehicles.

2. Description of the Related Art

Traffic congestion is a common occurrence in heavily populated areas. Traffic congestion results in slower speeds and longer travel times. This type of congestion typically occurs when traffic demand is greater than the capacity of a road or if traffic control systems, such as traffic lights, are not optimally set to facilitate the movement of traffic through intersections in an efficient manner. Rush hours and holidays are examples of times when traffic demand may become greater than the capacity of a road.

A traffic light, also referred to as a traffic signal, stop light, or traffic lamp, is a signaling device positioned at a road intersection or other location to indicate when traffic in an intersection may cross the intersection. Typically, a traffic signal may change state to signal when traffic can cross an intersection using different types of controls. A fixed timed control, a dynamic control, and a coordinated control are examples of controls that may be used. A fixed timed control uses a timer such that each phase or state of the signal lasts for a specific duration. A dynamic control system may use sensors buried in the pavement to detect the presence of traffic waiting at the light and may avoid giving a green light to an empty road while vehicles in route are stopped at the intersection.

A coordinated control system may be used to coordinate or synchronize signals for traffic lights such that drivers encounter long strings of green lights. Coordination may be performed in real time to deal with changing traffic patterns. For example, video cameras at intersections may be used to monitor traffic patterns in a city. A video camera may identify when traffic is being impeded at a particular signal. A video camera may be used to identify when traffic is sitting at a light or when traffic is not present at a light. With this information, the timing signals may be altered to increase the flow. In addition, loops or sensors buried in the ground at traffic lights also may be used to identify traffic patterns when vehicles are present at an intersection where a traffic light is present.

### SUMMARY OF THE INVENTION

The illustrative embodiments provide a computer implemented method, apparatus, and computer usable program code for controlling traffic. A set of vehicles is monitored moving from one radio frequency identification tag sensor to another radio frequency identification tag sensor in a network of radio frequency identification tag sensors to detect movement of the set of vehicles. A set of traffic patterns is identified in response to detecting the movement of the set of vehicles. A determination is made as to whether a traffic pattern in the set of traffic patterns is a delayed traffic pattern. In response to a determination that the traffic pattern in the set of traffic patterns is the delayed traffic pattern for a traffic control light at an intersection, the timing of the traffic control light is changed to increase traffic flow through the intersection.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a diagram illustrating components in a traffic network in accordance with an illustrative embodiment;

FIG. 4 is a diagram illustrating components used to manage a traffic network in accordance with an illustrative embodiment;

FIG. 5 is a flowchart of a process for managing traffic lights in accordance with an illustrative embodiment; and

FIG. 6 is a flowchart of a process for identifying a traffic pattern in accordance with an illustrative embodiment.

### DETAILED DESCRIPTION OF THE PREFERRED EMBODIMENT

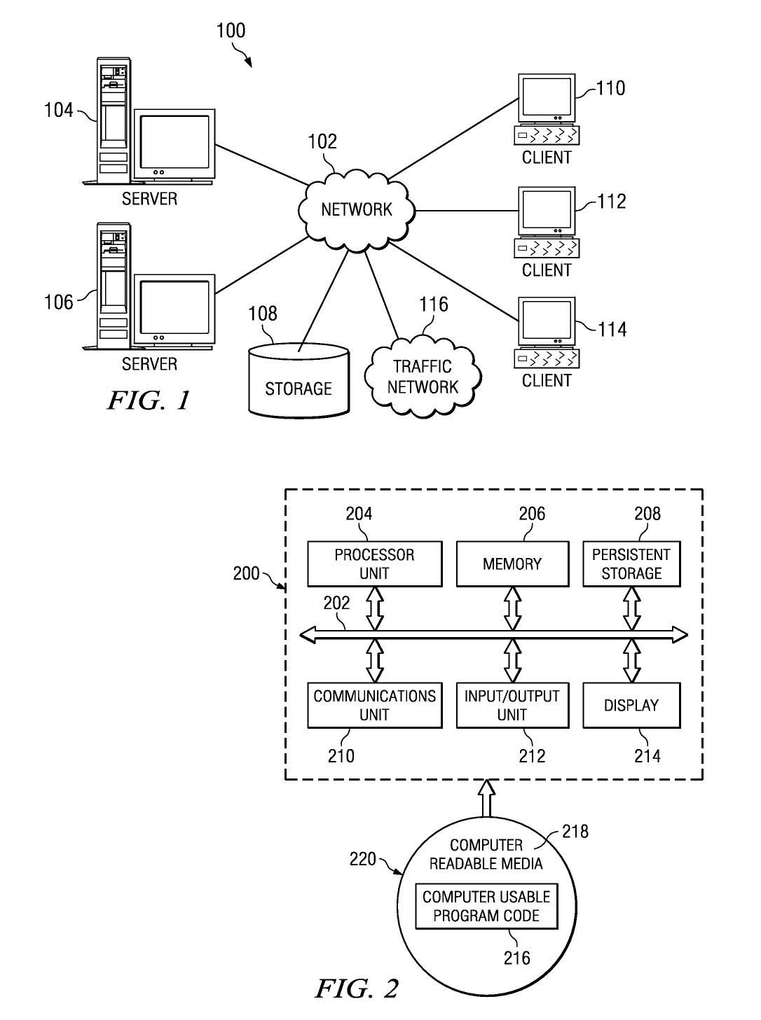

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example.

Additionally, network data processing system 100 includes traffic network 116. In these examples, traffic network 116 includes traffic control mechanisms, such as traffic lights and information signs. The traffic lights are used to control flow across intersections in a geographic area, such as a city. Information signs are programmable to present or display information to drivers of vehicles.

For example, an information sign may identify the amount of time needed to reach a particular exit or intersection from the location of the sign. Information signs also may be used to provide information about accidents that may have occurred and delays. Also, other traffic control mechanisms may include indicators that identify when lanes are closed or open.

Traffic network 116 also includes a network of sensors that may include video cameras, loop detectors in the ground, and radio frequency identification tag readers. These radio frequency identification tag readers are also referred to as radio frequency identification tag sensors. These sensors in traffic network 116 are used to obtain information to control signal lights and present information to drivers on information signs.

In the depicted examples, radio frequency identification tag readers are used to provide additional information that may be used to provide a more complete picture of traffic flow. The different illustrative embodiments recognize that the current use of video cameras and loop detectors are only able to identify the presence of vehicles at traffic lights and intersections, but cannot identify how many vehicles are actually lined up in one direction or the other. Further, the different illustrative embodiments also recognize that the movement of these vehicles along a route or path cannot be identified using the current systems.

Thus, the different illustrative embodiments use radio frequency identification sensors to obtain information about vehicle movement. By identifying specific vehicles through radio frequency identification tags, the movement or progress of those vehicles through roads and intersections may be identified. With this additional information, better coordination and better traffic management may occur.

In these examples, a data processing system, such as server 104 may receive and store information retrieved from radio frequency identification tag sensors in traffic network 116. This information may be stored locally within server 104, or may be stored in a storage device, such as storage unit 108. Analysis of this information may be used to adjust timing of traffic lights within traffic network 116.

Depending on the particular implementation, the traffic control processes may be located or managed at a client, such as client 114. All the processes may be located on a single server or distributed on other data processing systems, such as server 104 and client 110. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages.

Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

As an example, data processing system 200 may be used to implement the processes and computer usable program code that processes traffic data from traffic network 116 in FIG. 1 to identify the movement of vehicles from a location to another location. Further, with this information, commands and/or other control information may be sent to traffic network 116 to optimize the flow of traffic within traffic network 116 in FIG. 1.

In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as computer usable program code or computer readable program code that may be read and executed by a processor in processor unit 204. The computer readable program code may be embodied on different physical or tangible computer readable media, such as memory 206 or persistent storage 208.

Computer usable program code 216 is located in a functional form on computer readable media 218 and may be loaded onto or transferred to data processing system 200. Computer usable program code 216 and computer readable media 218 form computer program product 220 in these examples. In one example, computer readable media 218 may be, for example, an optical or magnetic disc that is inserted or placed into a drive or other device that is part of persistent storage 208 for transfer onto a storage device, such as a hard drive that is part of persistent storage 208. Computer readable media 218 also may take the form of a persistent storage, such as a hard drive or a flash memory that is connected to data processing system 200.

Alternatively, computer usable program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the computer readable program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The different advantageous embodiments recognize that the different traffic sensors currently used are only able to identify that vehicles are present when stopped at intersections and the directions in which they are present. These types of sensors, however, are unable to identify how many cars, such as ten or one-thousand cars are waiting in a particular direction.

Thus, the different advantageous embodiments use radio frequency identification sensors at locations, such as intersections, that are able to detect and identify radio frequency identification tags that may be present in the vehicles as they pass through an intersection or other location. These radio frequency identification tags may be tags specifically for these purposes or may employ existing tags. For example, radio frequency identification toll tags may be detected at these locations. With this information, the different advantageous embodiments are able to detect in real-time how long it takes a particular vehicle to move from one intersection to another intersection within a traffic or road system.

The different advantageous embodiments provide a computer implemented method, apparatus, and computer usable program code for controlling traffic. The process monitors a set of vehicles moving from one sensor to another sensor in a network of radio frequency identification tag sensors to detect the movement of the set of vehicles. A set of vehicles is one or more vehicles in these examples.

In these examples, the movement is for the particular set of vehicles, which may be identified. The movement in these examples may be, for example, the movement of a vehicle from one intersection to another intersection or from one location to another location at which radio frequency identification sensors are located. This movement may include the amount of time it takes for a vehicle to move from one location to another location.

A set of traffic patterns are identified in response to detecting the movement of the set of vehicles. The set of traffic patterns are one or more traffic patterns. This set of traffic patterns is more comprehensive than current patterns because the patterns actually identify the number of vehicles that are located or moving on different roads and lanes, rather than just the presence of stopped traffic or vehicles at an intersection or the movement of vehicles through an intersection. In response to identifying a traffic pattern in the set of traffic patterns that is a delayed traffic pattern for a traffic control light at an intersection, the timing of the traffic control light may be changed to increase the traffic flow through the intersection.

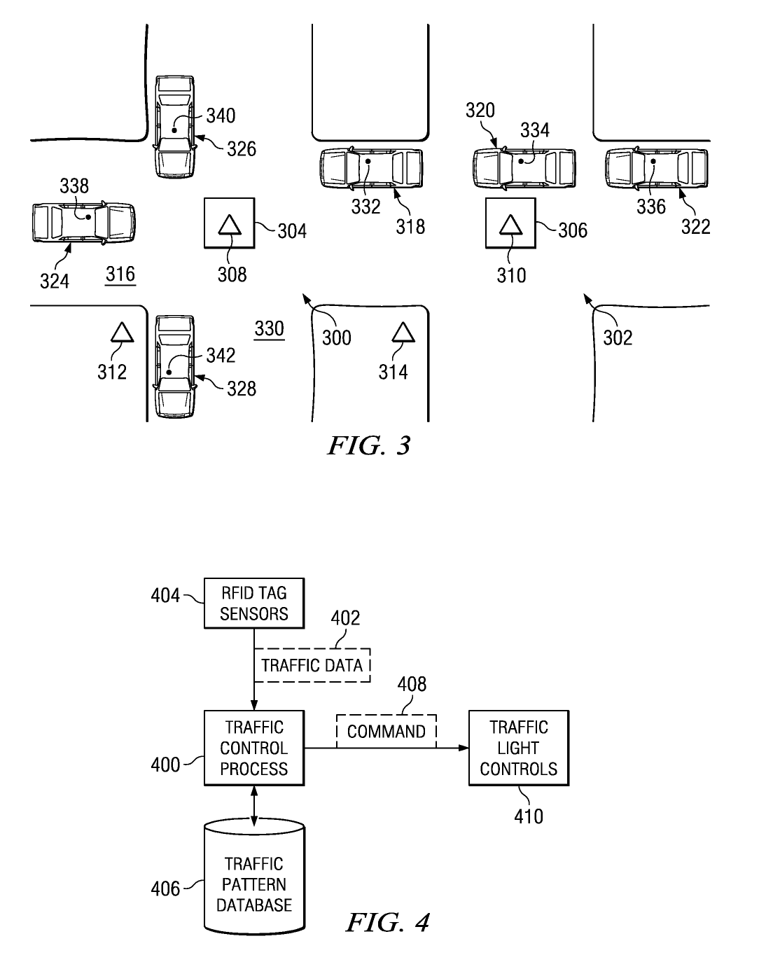

Turning now to FIG. 3, a diagram illustrating components in a traffic network is depicted in accordance with an advantageous embodiment. In these examples, the components may be located in a traffic network, such as traffic network 116 in FIG. 1. In this particular example, intersections 300 and 302 are present. Intersection 300 includes traffic light 304, while intersection 302 contains traffic light 306. Traffic lights 304 and 306 also include radio frequency identification tag sensors 308 and 310. These radio frequency identification sensors are also referred to as radio frequency identification readers.

Typically, these sensors include a transmitter and a receiver. The transmitter in each of these sensors generates a radio frequency field, which causes a signal to be returned by a radio frequency identification tag that is present within the range of the field. The receiver receives any information that may be returned by these radio frequency identification tags. This information may include, for example, a unique identifier or serial number as well as other data that may be located within the memory of the radio frequency identification tag.

In addition, radio frequency identification sensors may be mounted in other locations. In these examples, radio frequency identification tag sensors 312 and 314 also are located along the side of road 316.

In this illustrative example, vehicles 318, 320, and 322 are traveling along one direction on road 316, while vehicle 324 is traveling in another direction along road 316. Vehicle 324 is stopped at light 304 with vehicles 326 and 328 moving across intersection 300 along road 330. In these examples, radio frequency identification tags 332, 334, 336, 338, 340, and 342 are located in vehicles 318, 320, 322, 324, 326, and 328 respectively.

Radio frequency identification tag sensors 308, 310, 312, and 314 detect the presence of each vehicle as each vehicle passes by a particular sensor. Additionally, each of these sensors is able to identify a specific vehicle based on a unique identifier that may be transmitted from the radio frequency identification tags.

With this information, the time needed for a particular vehicle to move from one location to another location, such as from intersection 300 to intersection 302, may be identified. Locations identified for the radio frequency identification tags also may be at different parts or sections of the road rather than at intersections, such as the locations at which radio frequency identification sensors 312 and 314 are located.

With a unique identification of each radio frequency identification tag, the actual time needed for a particular vehicle to move along a road from point to point or location to location may be identified. The movement of a set of vehicles along a road, such as road 316 may be used to identify a traffic pattern. This set of vehicles may be one or more vehicles. This traffic pattern may be compared to other stored or known traffic patterns that indicate when non-delayed or delayed travel times are present. For example, a pattern may be a travel time needed to travel through a number of intersections at a particular time of day, on a selected day of the week.

With this information, adjustments to the timing of traffic lights 304 and 306 may be made to increase the flow of traffic. In these examples, traffic flow may be optimized by increasing the flow of traffic as much as possible. This optimization may be for a particular light, or may be for a particular set of lights along a road. Further, the optimization of the movement of traffic may involve the overall movement of traffic at numerous lights within a geographic area, such as a set of city blocks, or an entire city.

In addition, traffic control information obtained from radio frequency identification tags on vehicles is not required for every vehicle that is on the road. In these examples, traffic patterns may be established from a small number of vehicles. In these examples, the number of vehicles may be used, but is not the only information that may be used. In other illustrative embodiments, another parameter or piece of information used in identifying traffic patterns is the time needed for a particular vehicle to move from one location to another location.

Turning now to FIG. 4, a diagram illustrating components used to manage a traffic network is depicted in accordance with an advantageous embodiment. In these examples, traffic control process 400 is an example of a traffic control process that may be implemented in a data processing system, such as data processing system 200 in FIG. 2. Traffic control process 400 receives traffic data 402 from radio frequency identification (RFID) tag sensors 404.

This information is processed by traffic control process 400 to identify particular vehicles and the time it takes particular vehicles to move from one location to another location. In these examples, traffic control data 402 may include a unique identifier, a time stamp, and a sensor location or identifier. The unique identifier is used to uniquely identify a particular vehicle, such that the movement of the vehicle may be tracked along with the amount of time it takes the vehicle to move from one location to another location. The time stamp is used to indicate when the vehicle was detected at a particular radio frequency identification sensor. The identification or location of the radio frequency identification sensor is used to identify the location of the vehicle in these examples.

Traffic control process 400 processes this traffic data to identify the time it takes vehicles to move along different roads. This movement along a set of points on a road may form a traffic pattern in these examples. In these examples, movement also includes the time needed for a vehicle to move along a set of points. The identified traffic pattern is compared to known traffic patterns in traffic pattern database 406. In these examples, the patterns in traffic pattern database 406 may be known patterns of movement of non-delayed travel times. For example, traffic pattern database 406 may contain an amount of time needed to move from one location to another location that is not considered a delay. These times may change for different periods of time, such as different times of the day and on different days of the week, or even different days of the month. Also, holidays may affect what is considered un-congested. These different times at different periods of time may form traffic patterns.

If delays are found, traffic control process 400 may identify a modification or change in timing for one or more traffic lights within the traffic network. This type of process may use currently available intelligent computer processes to dynamically adjust light timing. These types of processes are currently used, but are not used effectively because of the limited information that current sensors provide. With the actual identification of movement from one location to another location, and the time it takes, dynamic changes to timing of lights may be made to more efficiently optimize the movement of traffic within a traffic network to increase the flow in the traffic network. When this information is identified, the change timing may be sent in command 408 to traffic light controls 410, which controls the timing of traffic lights within the traffic network.

Traffic control process 400 may also estimate how many red light cycles a particular vehicle sat through or the average speed of the vehicle while moving from one light to the next light. All of this information may be identified by the time it takes for a vehicle to move from one sensor to another sensor.

Further, traffic control process 400 also may filter the data to remove data about vehicles that are outside of a statistical curve. This type of processing may account for vehicles that have stopped for gas or other diversions. Additionally, with this type of implementation, the identification of the owner of the vehicle is not needed. As a result, access to a database of toll tag owners is unnecessary. Only the unique identifier is required when existing radio frequency identification toll tags are used.

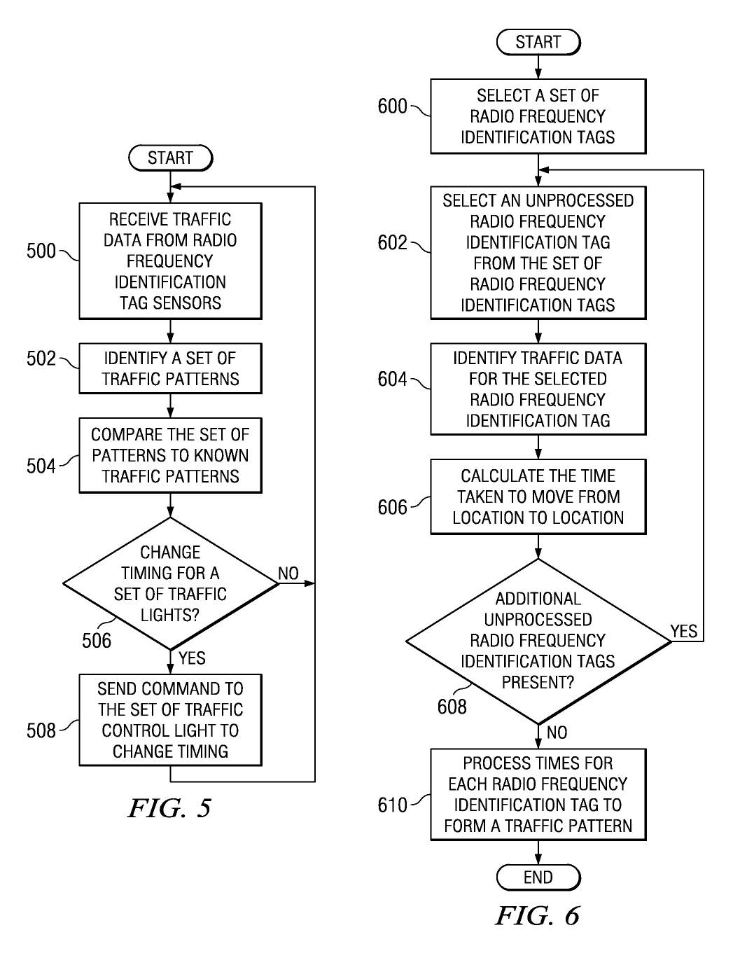

Turning now to FIG. 5, a flowchart of a process for managing traffic lights is depicted in accordance with an illustrative embodiment. The process illustrated in FIG. 5 may be implemented in a process, such as traffic control process 400 in FIG. 4.

The process begins by receiving traffic data from radio frequency identification tag sensors (step 500).

Thereafter, a set of traffic patterns are identified (step 502). In these examples, the set of traffic patterns may be one or more traffic patterns. Each traffic pattern may relate to a particular road or route in a traffic network. The patterns may include information, such as, for example, the time it takes a vehicle to move from one location to another location, the number of red light cycles a particular vehicle sat through, and/or the average speed of a vehicle while moving from one light to another light.

The process then compares the set of traffic patterns to known traffic patterns (step 504). A determination is made as to whether the timing for a set of traffic lights is needed (step 506). This set of traffic lights may be one or more traffic lights. In step 506, the traffic pattern identified from the traffic data may be compared to stored traffic patterns. This comparison may take various forms. For example, the comparison may be the time needed to cross a particular intersection. In other examples, the traffic pattern may be the time needed to travel from one point to another point along one or more roads.

If a change is not needed the process returns to step 500. Otherwise, a command is sent to the set of traffic control lights to change the timing (step 508) with the process then returning to step 500.

Turning next to FIG. 6, a flowchart of a process for identifying a traffic pattern is depicted in accordance with an illustrative embodiment. The process illustrated in FIG. 6 may be a more detailed description of step 502 in FIG. 5. This particular process may be performed for each roadway or route to identify a traffic pattern for that roadway or route.

The process begins by selecting a set of radio frequency identification tags for processing (step 600). In these examples, the set of radio frequency identification tags are selected as ones for vehicles that have passed through, or have been detected, at certain locations in the traffic network. The process then identifies an unprocessed radio frequency identification tag from the set of radio frequency identification tags (step 602). The process identifies traffic data associated with the selected radio frequency identification tag (step 604).

Next, the process calculates the time taken to move from location to location for the radio frequency identification tag (step 606). Step 606 may involve identifying times to move between two locations. Alternatively, multiple locations may be present and the time to move from one location to another location may be identified, as well as the total time to move from the first location to the last location. This information is identified as movement for the vehicle associated with the radio frequency identification tag.

A determination is made as to whether additional unprocessed radio frequency identification tags are present (step 608). If additional tags are present, the process returns to step 602 to select another unprocessed radio frequency identification tag for processing.

Otherwise, the times for each tag are processed to form a traffic pattern (step 610). Step 610 may include identifying average time or set of times for traffic to move from one location to another location. Additionally, this step may be used to throw out, or filter out, times for tags in which no movement has occurred because of a diversion, such as stopping for gas or stopping at a store.

Thus, the different illustrative embodiments provide a computer implemented method, apparatus, and computer usable program code for controlling traffic. The different illustrative embodiments monitor a set of radio frequency identification tags located in a set of vehicles moving from one radio frequency identification tag sensor to another radio frequency identification tag sensor in a network of radio frequency identification tag sensors relative to a traffic light to obtain location data for the set of vehicles. The times needed for the set of vehicles to travel from one radio frequency identification tag sensor to another radio frequency identification tag sensor form time data. The movement of the vehicles is identified using the time data to form a traffic pattern relative to the traffic light.

With this information, a determination may be made as to whether the traffic pattern is a delayed traffic pattern for the traffic light. In response to the determination that the traffic pattern is a delayed traffic pattern for the traffic light, the timing of the traffic light may be changed to increase the traffic flow through the intersection at which the traffic light is located.

The different illustrative embodiments provide an ability to identify the actual pattern of movement, rather than just a presence of traffic at a particular intersection. In this manner, more efficient optimizations of traffic flow may be made by controlling the timing of the traffic light control.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for controlling traffic flow, the computer implemented method comprising:
monitoring a set of radio frequency identification tags located in a set of vehicles moving from one radio frequency identification tag sensor to another radio frequency identification tag sensor in a network of radio frequency identification tag sensors relative to a traffic light to obtain location data for the set of vehicles;
identifying times needed for the set of vehicles to travel from the one radio frequency identification tag sensor to the another radio frequency identification tag sensor to form time data;
identifying a traffic pattern relative to the traffic light from the time data;
determining whether the traffic pattern is a delayed traffic pattern for the traffic light; and
responsive to a determination that the traffic pattern is a delayed traffic pattern for the traffic light, changing timing of the traffic light to increase the traffic flow through the intersection.

2. The computer implemented method of claim 1, wherein the traffic pattern comprises the time data, number of cycles a vehicle in the set of vehicles sat at the traffic light, and an average speed of the set of vehicles.

3. The computer implemented method of claim 1, wherein the set of radio frequency identification tags are a set of radio frequency identification toll tags.

4. The computer implemented method of claim 1, wherein the determining step comprises:
comparing the traffic pattern to non-delayed traffic times for the traffic light to form a comparison; and
determining whether the traffic pattern is the delayed traffic pattern for the traffic light using the comparison.

5. A computer implemented method for controlling traffic, the computer implemented method comprising:
monitoring a set of vehicles moving from one radio frequency identification tag sensor to another radio frequency identification tag sensor in a network of radio frequency identification tag sensors to detect movement of the set of vehicles;
identifying a set of traffic patterns in response to detecting the movement of the set of vehicles;
determining whether a traffic pattern in the set of traffic patterns is a delayed traffic pattern; and
responsive to a determination that the traffic pattern in the set of traffic patterns is a delayed traffic pattern for a traffic control light at an intersection, changing timing of the traffic control light to increase traffic flow through the intersection.

6. The computer implemented method of claim 5, wherein the intersection is a first intersection and further comprising:
responsive to a determination that a traffic pattern in the set of traffic patterns is a delayed traffic pattern for the traffic control light at an intersection, changing timing of a preceding traffic control light at another intersection to increase traffic flow through the intersection.

7. The computer implemented method of claim 6, wherein the identifying step comprises:
identifying how much time is required for a set of vehicles to pass from one radio frequency identification tag sensor to another radio frequency identification tag sensor.

8. The computer implemented method of claim 7, wherein the determining step comprises:
comparing the set of traffic patterns to a database of traffic patterns to determine whether the traffic pattern in the set of traffic patterns is the delayed traffic pattern.

9. A computer program product comprising:
a computer usable medium having computer usable program code for controlling traffic flow, the computer program product comprising:
computer usable program code for monitoring a set of radio frequency identification tags located in a set of vehicles moving from one radio frequency identification tag sensor to another radio frequency identification tag sensor in a network of radio frequency identification tag sensors relative to a traffic light to obtain location data for the set of vehicles;
computer usable program code for identifying times needed for the set of vehicles to travel from the one radio frequency identification tag sensor to the another radio frequency identification tag sensor to form time data;
computer usable program code for identifying a traffic pattern relative to the traffic light from the time data;
computer usable program code for determining whether the traffic pattern is a delayed traffic pattern for the traffic light; and
computer usable program code responsive to a determination that the traffic pattern is a delayed traffic pattern for the traffic light, for changing timing of the traffic light to increase the traffic flow through the intersection.

10. The computer program product of claim 9, wherein the traffic pattern comprises the time data, a number of cycles a vehicle in the set of vehicles sat at the traffic light, and an average speed of the set of vehicles.

11. The computer program product of claim 9, wherein the set of radio frequency identification tags is a set of radio frequency identification toll tags.

12. The computer program product of claim 9, wherein the computer usable program code for determining whether the traffic pattern is a delayed traffic pattern for the traffic light comprises:
computer usable program code for comparing the traffic pattern to non-delayed traffic times for the traffic light to form a comparison; and
computer usable program code for determining whether the traffic pattern is the delayed traffic pattern for the traffic light using the comparison.
